(19) United States
(12) Patent Application Publication
(10) Pub. No.: US 2015/0288762 A1
(43) Pub. Date: Oct. 8, 2015

(54) FILE STORAGE SYSTEM AND METHOD FOR MANAGING USER DATA

(71) Applicant: HITACHI, LTD., Tokyo (JP)

(72) Inventors: Akira Ito, Tokyo (JP); Hitoshi Kamei, Tokyo (JP)

(21) Appl. No.: 14/373,373

(22) PCT Filed: Mar. 22, 2013
(86) PCT No.: PCT/JP13/58274

§ 371 Date: Jul. 21, 2014

(51) Int. Cl. H04L 29/08

(52) U.S. Cl. CPC H04L 67/1097; H04L 67/06

(57) ABSTRACT

The present invention provides a system, wherein when operations such as a deleting of an ID or a changing of a group to which an ID belongs is carried out, the data range within the file system influenced by the operation is efficiently specified from the enormous amount of data within the file system, and with the aim to prevent retention of data whose owner has become absent or loss of authority to execute management operations, the file storage system records the hierarchical relationship of users and groups capable of accessing respective file sharing directories, so as to specify the range influenced by the operation performed to IDs in the ID management server, carry out a searching operation targeting only the file sharing directory being influenced within the file system, specify files and directories whose owners have become absent, and carry out processes such as deleting or transferring of ownership.

### TECHNICAL FIELD

The present invention relates to a storage system, and more specifically, in a file storage system cooperating with an ID management server for managing user IDs capable of accessing file sharing directories, relates to the art of specifying the influences of operations related to IDs regarding the capability of access from users to data accompanying the operations regarding the IDs in a file storage subsystem, and handling data whose owner has become absent.

### BACKGROUND ART

In a file storage system, the access to files stored in the storage system is carried out via authentication using an authentication system. An authentication system authenticates users using information (such as user name and password) for uniquely identifying the accessing users. The access capability of a user authenticated by the authentication system is determined based on an access right setting (such as an ACL) set for each file or directory. The authentication system utilizes, for example, a directory service for storing user information (such as an LDAP (Lightweight Directory Access Protocol) service, or Active Directory provided by Microsoft) or a database, and also utilizes Kerberos or the like as the authentication mechanism. The server in which a directory service or the like is operated for registering users for authentication purposes is called an “ID management server” in the present specification.

If a user or a group of users registered in the ID management server is changed or deleted, the users capable of accessing the related file storage subsystem are influenced. If a user capable of accessing the file sharing directory in the file storage subsystem is deleted from the ID management server, the user will no longer be able to access that file sharing directory. However, the file owned by the user still remains. Therefore, arts disclosed in patent literatures 1 and 2 are provided as examples of prior art techniques for coping with the data whose user having the ownership thereof is absent, or which is access-disabled data.

### CITATION LIST

### Patent Literature

### [PTL 1]

U.S. Pat. No. 8,006,309
(International Patent Application Publication No. WO2005/015420)

### [PTL 2]

### US Patent Application Publication No. 2011/0231364

### (Japanese Patent Application Laid-Open Publication No. 2011-198109)

### SUMMARY OF INVENTION

### Technical Problem

As described, with reference to the prior art, if users or a group of users registered in the ID management server are changed or deleted, the users capable of accessing the related file storage subsystem will be influenced. If a user capable of accessing the file sharing directory in the file storage subsystem is deleted, the user will no longer be able to access that file sharing directory. However, since the file owned by that owner still remains, an unnecessary file owned by a deleted user will remain stored in the file storage subsystem, by which the efficiency of use of capacity is deteriorated. When a user is deleted, the files or directories owned by that user will be in an owner-absent state. This means that the only person capable of executing operations permitted by the owner becomes absent, which brings about obstacles to the management of files and directories.

Further, if a group to which a user or a group of users belongs is changed and the user/group hierarchy is changed, the access availability to a file sharing directory may be changed. If a user is withdrawn from a certain group, the withdrawn user will be disabled from accessing a shared directory whose access right is provided to that group. Even in such case, the user having the ownership will no longer be able to manage files, which pose a problem for management.

If a user having an ownership of a file or a directory becomes absent or incapable of accessing the file or the directory, the system can cope with the problem by performing operations such as deleting or transferring of ownership of the file or directory, but if there are a large number of files and directories owned by that user, high costs are required to search for the files and directories owned by that user from the whole file system. Further, since the user/group hierarchical information and access rights related to the file sharing directory are managed independently by the file storage subsystem and the ID management server, it may be difficult to actually specify which user is capable of accessing the file sharing directory.

### Solution to Problem

In the present invention, a server includes an ID management unit for managing an ID of a user capable of accessing a file or a directory or an ID of a group which is an assembly of users, and a file storage subsystem capable of connecting with a server via a network includes a table for recording the ID of a user or an ID of a group capable of accessing a file sharing directory and a hierarchical relationship of the IDs, and a control unit for carrying out a processing related to the file and the directory based on the information acquired from the ID management unit of the server, wherein when a change information related to the user ID or the group ID recorded in the table is acquired from the ID management unit, the control unit refers to the table to specify the file sharing directory that the ID of the user or the ID of the group being changed is capable of accessing, and carries out a processing required by the change to the files or directories belonging to the specified file sharing directory (such as deleting of an ID or changing of group hierarchy).

### Advantageous Effects of Invention

According to the present invention, data remaining in the file storage subsystem whose owner is absent can be subjected to appropriate processing. For example, the efficiency of use of capacity can be improved by deleting files whose owners are absent. Moreover, when an owner becomes absent through transfer of ownership, management of data can be taken over by a different user.

### BRIEF DESCRIPTION OF DRAWINGS

FIG. 1 is an overall configuration diagram of a file storage system according to the present invention.

FIG. 2 is an internal configuration diagram of a file storage subsystem.

FIG. 3 is an internal configuration diagram of an ID management server.

FIG. 4 is a view showing one example of a shared access enabled user/group table.

FIG. 5 is a view showing one example of a file processing policy.

FIG. 6 is a flowchart showing an update processing of a shared access enabled user/group table.

FIG. 7 is a part (former half) of a flowchart showing the procedure for processing a user-owned file accompanying the deleting of user ID according to a first embodiment of the present invention.

FIG. 8 is a part (latter half) of a flowchart continuing from the flowchart shown in FIG. 7.

FIG. 9 is a part (former half) of a flowchart showing the procedure for processing a user-owned file accompanying the change of group to which a user ID belongs as a second embodiment of the present invention.

FIG. 10 is a part (latter half) of a flowchart continuing from the flowchart shown in FIG. 9.

### DESCRIPTION OF EMBODIMENTS

The configuration of a file storage system having an ID management server is illustrated as a preferred embodiment of the present invention, and cases where a user or a group to which the user belongs is deleted or cancelled will be illustrated as the actual examples.

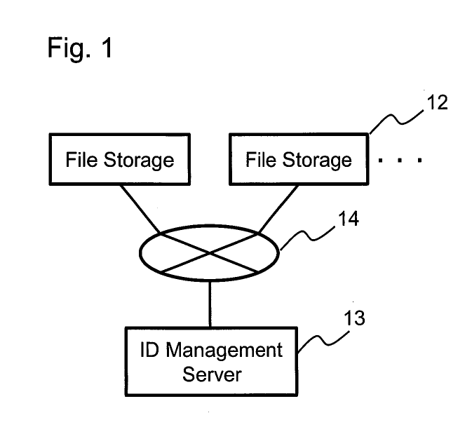

FIG. 1 is an overall configuration diagram of a file storage system according to the present invention. In the system, one or more file storage subsystems 12 and an ID management server 13 are connected via a network 14 composed of a WAN, a LAN or the like.

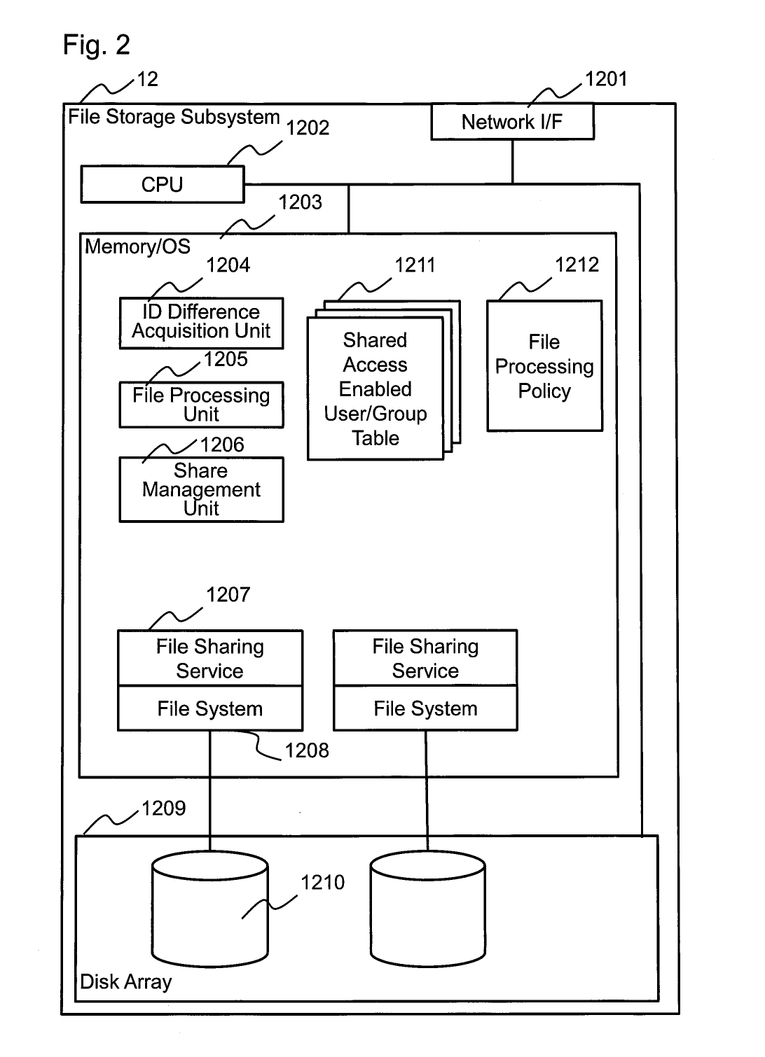

FIG. 2 is an internal configuration diagram of a file storage subsystem 12 within the overall configuration illustrated in FIG. 1. The file storage subsystem 12 is composed of a network I/F 1201 for connecting the subsystem to other computers or storage subsystems, a CPU 1202 for carrying out operations of programs, a memory and an OS 1203 operating thereon, and a disk array 1209 for storing data.

The memory and OS 1203 operating thereon includes an ID difference acquisition unit 1204 for receiving the change information of ID information from the ID management server 13 and determining the influence accompanying this change of ID, a file processing unit 1205 for carrying out processes regarding files, a share management unit 1206 for managing file sharing directories and executing processes related thereto, one or more file sharing services 1207 for opening files in the file system to users, one or more file systems 1208 for managing files and directories, a shared access enabled user/group table 1211 for recording the users capable of accessing the file sharing directory, and a file processing policy 1212 for defining the contents of processing regarding files and directories in response to the change of ID. In this example, the ID difference acquisition unit 1204, the file processing unit 1205 and the share management unit 1206 can be recognized as a single group of units capable of exerting the function of a control unit.

The disk array 1209 is composed of one or more volumes for storing the files in the file system 1208.

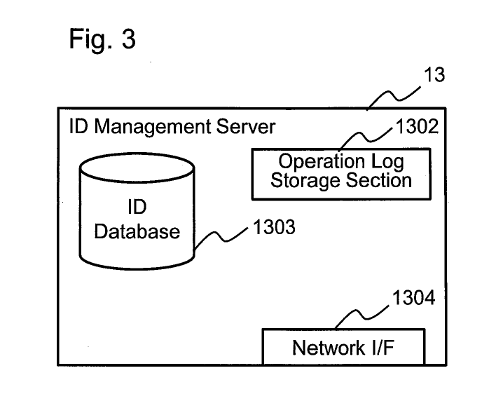

FIG. 3 is an internal configuration diagram of the ID management server 13 illustrated in the overall configuration of FIG. 1. The ID management server 13 is composed of an operation log storage unit 1302 for storing logs recording the change of ID information and the like, an ID database 1303 for storing the ID information, and a network OF 1304 for connection with other computers and storage subsystems.

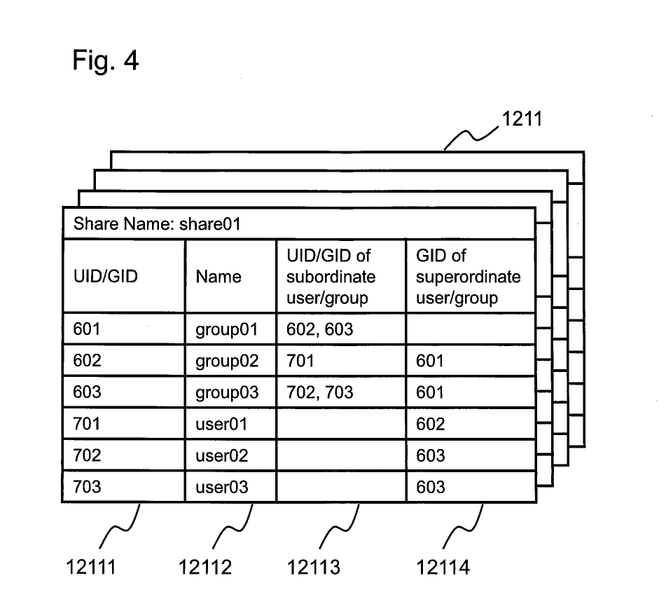

FIG. 4 is a view showing one example of the shared access enabled usergroup table 1211 retained in the file storage subsystem 12. One table is retained for each file sharing directory, and each table is composed of a column 12111 storing the UID of the users or the GID of the groups capable of accessing shared files and directories, a column 12112 storing the names of the users or groups (hereinafter abbreviated as “usersgroups”), a column 12113 storing the UIDs or the GIDs of subordinate usersgroups of the relevant usersgroups, and a column 12114 for storing the GID of a superordinate group of the relevant usersgroups (in other words, the group to which the relevant usersgroups belong).

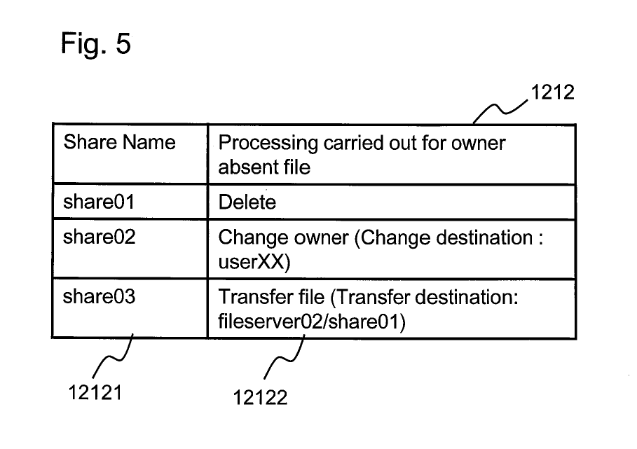

FIG. 5 is a view showing one example of a file processing policy 1212 retained by the file storage subsystem 12. The file processing policy 1212 is composed of a column 12121 for storing the share name of the file sharing directory, and a column 12122 for defining the contents of processing of the files and directories of which the owner is absent.

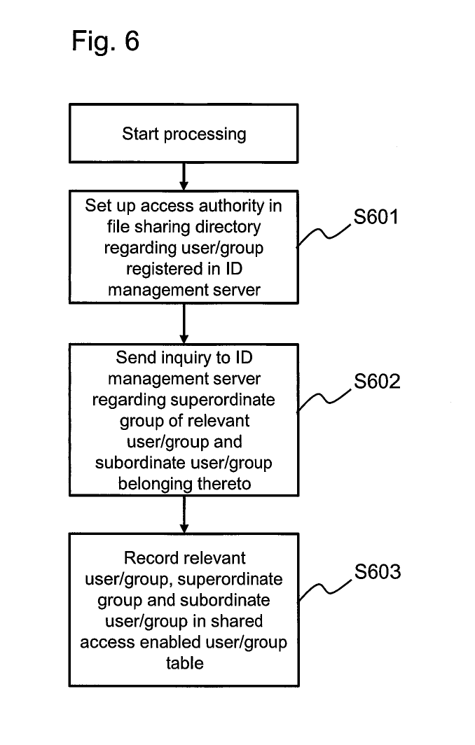

FIG. 6 is a flowchart showing the flow of an update processing of a shared access enabled usergroup table.

At first, a file storage administrator sets up an access authority in a file sharing directory regarding the usersgroups registered in the ID management server 13 (S601).

Next, the share management unit 1206 sends an inquiry to the ID management server 13 regarding a superordinate group to which the usersgroups set to have the access authority in the file sharing directory belongs and subordinate usersgroups belonging to the relevant usersgroups (S602).

Thereafter, based on the response from the ID management server 13 regarding this inquiry, the share management unit 1206 acquires all the UID and GID information of a superordinate group (to which the usersgroups capable of accessing the file sharing directory belong) and a subordinate usergroup (which belong to the usersgroups capable of accessing the file sharing directory), and based on the acquired information, the information related to the UID and GID of the relevant usersgroups, the superordinate group (to which the relevant usersgroups belong) and the subordinate usergroup (which belong to the relevant usersgroups) are recorded in the shared access enabled usergroup table 1211 (S603).

Based on the procedure described above, the usersgroups capable of accessing each file sharing directory can be recorded exhaustively based on the access right set up for each file sharing directory and the hierarchical relationship of usersgroups.

### Embodiment 1

As a first embodiment of the system configuration related to the present invention, the processing performed in a case where a user or a group to which the user belongs is deleted will be described hereafter with reference to the flowcharts.

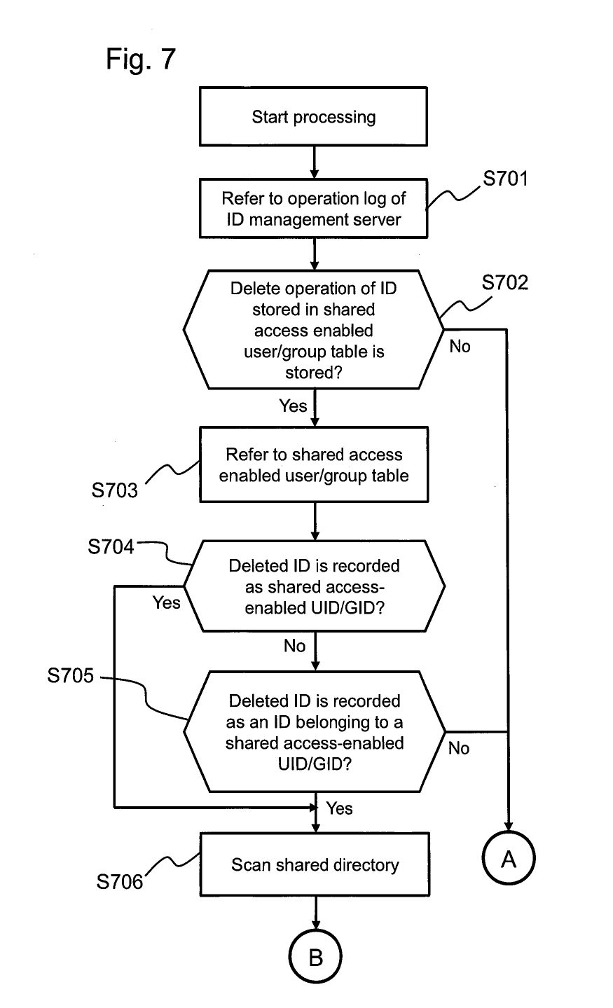

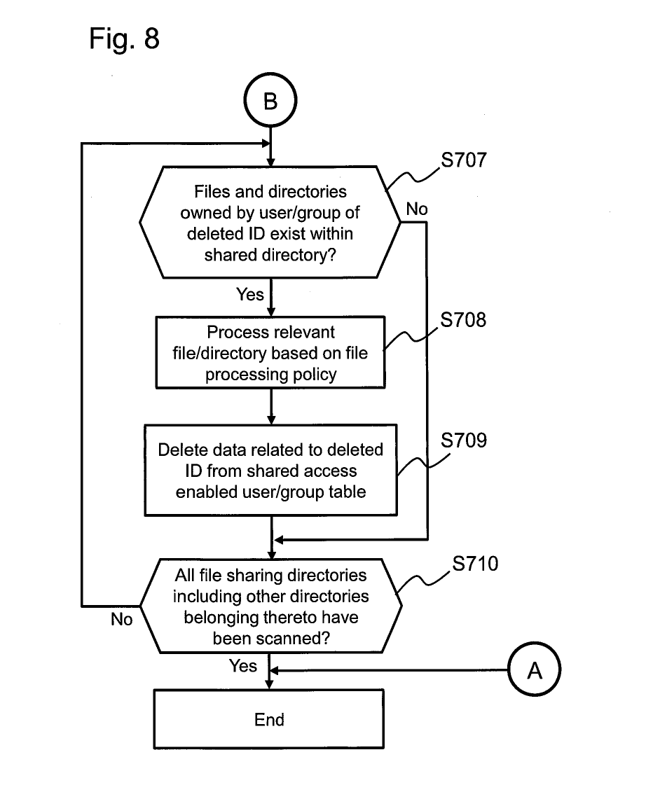

FIGS. 7 and 8 are flowcharts illustrating the flow of processes carried out when a user ID or a group ID is deleted from the ID management server 13.

At first, the ID difference acquisition unit 1204 refers to a log stored in an operation log storage section 1302 in the ID management server 13 (S701).

Next, the ID difference acquisition unit 1204 determines whether a delete operation related to the ID stored in the shared access enabled usergroup table 1211 is recorded in the above-mentioned log or not (S702). If delete operation is not stored (S702: No), the process is ended, and if delete operation is stored (S702: Yes), the ID difference acquisition unit 1204 refers to the contents of the shared access enabled usergroup table 1211 (S703).

Thereafter, the ID difference acquisition unit 1204 determines whether the shared directory in which the ID having been deleted from the ID management server 13 (hereinafter, this ID may be abbreviated as “deleted ID” in the specification and drawings) has been set to access enabled or not (S704). In other words, the ID difference acquisition unit 1204 scans a UIDGID column 12111 in the shared access enabled usergroup table 1211 to determine whether the deleted ID is included thereto, and if the deleted ID is not included in the column (S704), the unit determines in the subsequent step whether the deleted ID belongs to a subordinate of the shared access-enabled ID or not (S705).

In the present step 705 (S705), the ID difference acquisition unit 1204 scans the UIDGID column 12113 of the usersgroups belonging to the shared access enabled usergroup table 1211 to determine whether the deleted ID is included in the column or not. If the deleted ID is not included in the column (S705: No), the process is ended, but if the deleted ID is included in the column (S705: Yes) or if an ID deleted in the former step S704 is included in the UIDGID column 12111 (S704: Yes), the file processing unit 1205 scans the files and directories within the file system by restricting the area to the shared directories capable of being accessed by the deleted ID (S706).

Based on this scan, the file processing unit 1205 determines whether the files and directories owned by the usersgroups of the deleted ID exist within the relevant shared directory or not (S707), wherein if they do not exist (S707: No), the other directories belonging to the shared directory are scanned repeatedly, and if the corresponding files and directories exist (S707: Yes), processes based on the contents of a processing column 12122 to an owner absent file of the file processing policy 1212 are carried out with respect to the relevant files or directories (S708).

Next, as an update processing of the shared access enabled usergroup table 1211, the share management unit 1206 deletes a row having the ID deleted from the ID management server 13 as the value of column 12111, and as for the entry having the relevant deleted ID as the value of column 12113 and column 12114, the ID is deleted from the entry (S709).

The processes mentioned above are repeatedly performed for all the file sharing directories including the other directories belonging to the shared directory (S710: No), and when the processes are completed (S710: Yes), the processing is ended.

### Embodiment 2

As a second embodiment of a system configuration related to the present invention, the processing performed when the user or the group to which the user belongs is changed will be described hereafter with reference to the flowcharts.

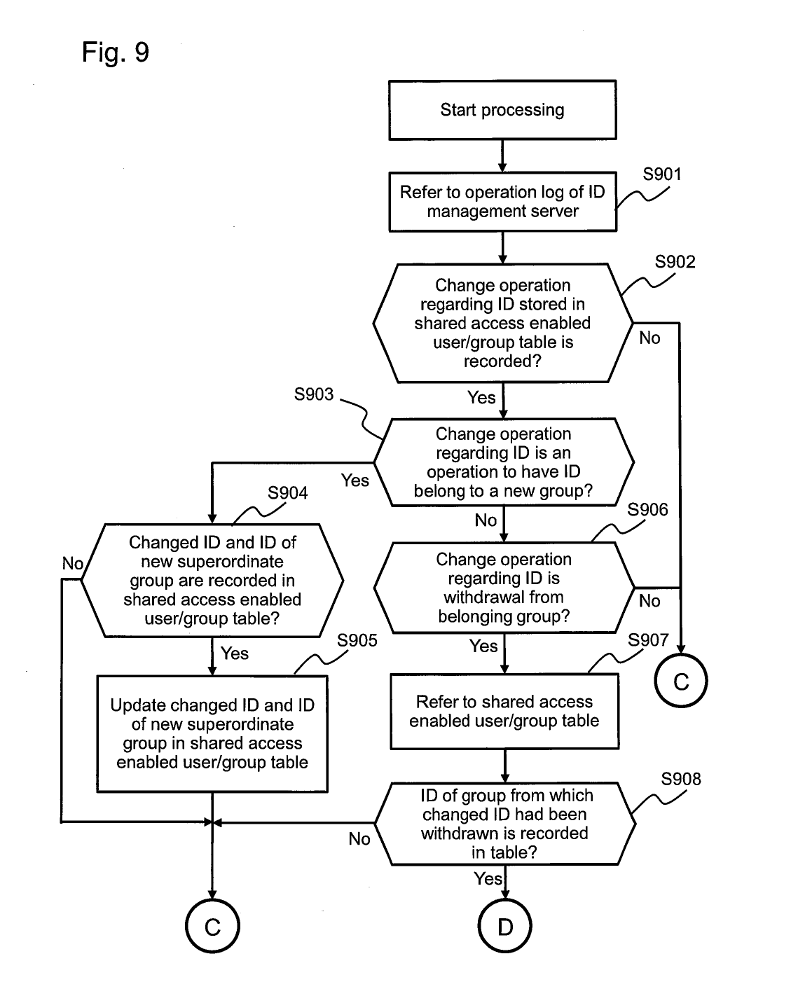

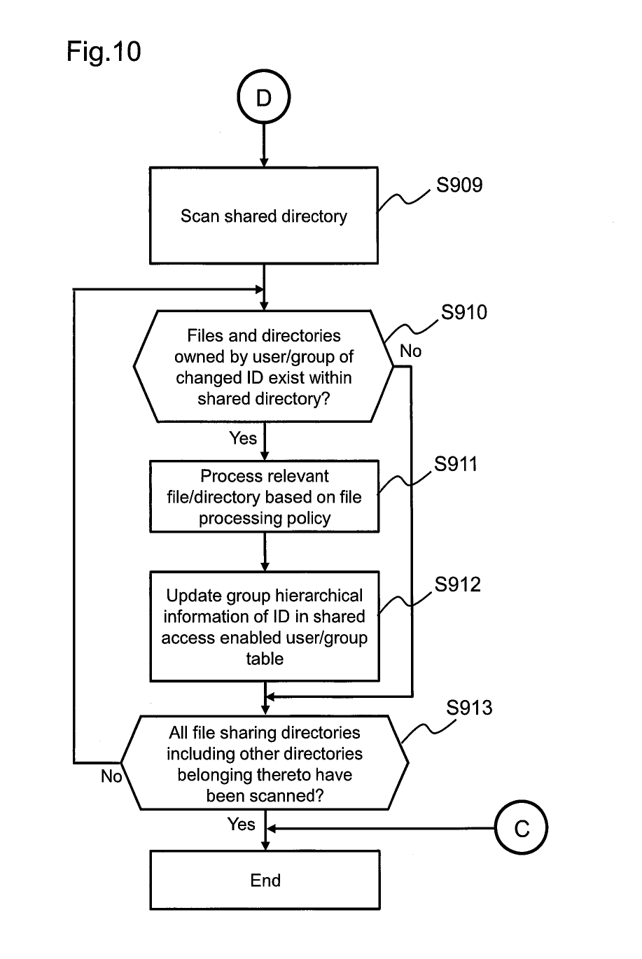

FIGS. 9 and 10 are flowcharts showing the flow of processing carried out when the user or the group to which the user belongs stored in the ID management server 13 is changed.

At first, similar to the previous delete processing, the ID difference acquisition unit 1204 refers to the log stored in the operation log storage section 1302 in the ID management server 13 (S901).

Thereafter, the ID difference acquisition unit 1204 determines whether a group changing operation regarding the ID stored in the shared access enabled usergroup table 1211 is recorded in the above-mentioned log or not (S902). If a group changing operation is not recorded (S902: No), the processing is ended, but if the operation is recorded (S902: Yes), the ID difference acquisition unit 1204 determines whether the group changing operation regarding the relevant ID is an operation to have the ID belong to a new group or not (S903).

If the operation regarding the relevant ID is an operation to have the ID belong to a new group (S903: Yes), the ID difference acquisition unit 1204 determines whether the ID having the group changed and the ID of the group to which the relevant ID newly belongs is stored in the shared access enabled usergroup table 1211 or not (S904). If they are not recorded (S904: No), the process is ended.

On the other hand, if they are stored (S904: Yes), the share management unit 1206 updates the shared access enabled usergroup table 1211, and updates the hierarchical relationship of the users and groups to reflect the latest relationship. Actually, the share management unit 1206 scans the shared access enabled usergroup table 1211, and if the ID having the group changed and the ID of the group to which the relevant ID newly belongs are included in the shared access enabled usergroup table 1211, the data in column 12113 or column 12114 of the corresponding row is updated (S905). After the update, the processing is ended.

Next, if the group changing operation regarding the above-mentioned ID in the above-mentioned step 903 (S903) is not an operation to have an ID belong to a new group (S903: No), the ID difference acquisition unit 1204 determines whether the group changing operation of the relevant ID is a withdrawal from a group to which the ID had belonged, and if it is not a withdrawal (S906: No), the process is ended.

On the other hand, if the group changing operation regarding the relevant ID is a withdrawal from the group to which the ID had belonged (S906: Yes), the ID difference acquisition unit 1204 refers to the UIDGID column 12111 of the shared access enabled usergroup table 1211 (S907), and determines whether the ID of the withdrawn group is included in the column or not (S908).

If the ID of the withdrawn group is not included in the column (S908: No), the processing is ended, but if the ID of the withdrawn group is included in the column (S908: Yes), the file processing unit 1205 determines that the ID withdrawn from the group was capable of accessing the shared memory by the authority of that group, and carries out a scan narrowing down the target to the relevant shared directory of the file system (S909).

Thereafter, if files or directories owned by the ID having been withdrawn from the group are not found within the shared directory (S910: No), the file processing unit 1205 scans other directories belonging to the shared directory, and ends the processing when overall scanning has been completed (S913). On the other hand, if corresponding files and directories are found in step 910 (S910: Yes), the file processing unit 1205 carries out the processing based on the contents of a processing column 12122 of owner absent files of the file processing policy 1212 for the relevant files or directories (S911).

Thereafter, as an update processing of the shared access enabled usergroup table 1211, the share management unit 1206 updates the contents of columns 12113 and 12114 of the row having the ID of which the superordinate group has changed in the value of column 12111, and deletes the ID of the withdrawn group (S912). The processing mentioned above is repeatedly performed for all file sharing directories including the other subordinate directories of the shared directory (S913: No), and when the processing is completed (S913: Yes), the processing is ended.

As described, according to embodiments 1 and 2, when deleting or changing operation is carried out to the users or groups capable of accessing a shared directory in the file storage subsystem 12 managed by the ID management server 13, the range influenced by the operation can be specified.

That is, the information on users or groups capable of accessing a shared directory including the hierarchical relationship of users or groups is stored in advance using the shared access enabled usergroup table 1211 stored in the file storage subsystem 12.

According to this operation, when a user ID or a group ID is deleted, it becomes possible to specify the shared directory that had been accessible from the deleted ID, and to restrict the search range within the file system to the relevant shared directory, in order to efficiently search and specify the file or the directory having lost its owner by the deleting of the ID, to thereby execute appropriate processes.

Even further, when the group to which the user or group belongs is changed and the hierarchical relationship of the users or groups is changed thereby, the present invention enables to specify the range being influenced by the change using the shared access enabled usergroup table 1211, and to execute appropriate processes to the files and directories in the shared directory that could not be accessed from the user having their ownership.

The present embodiment is designed so that the file storage subsystem 12 acquires change information of the ID from the ID management server 13, but the present embodiment can also be designed so that a program stored in the ID management server 13 sends information to the file storage subsystem 12 when necessary.

### REFERENCE SIGNS LIST

12: File storage subsystem
13: ID management server
14: Network (such as WAN or LAN)
1201: Network IF
1202: CPU
1203: Memory and OS operating therein
1204: ID difference acquisition unit
1205: File processing unit
1206: Share management unit
1207: File sharing service
1208: File system
1209: Disk array
1210: Volume
1211: Shared access enabled usergroup table
1212: File processing policy
1302: Operation log storage section
1303: ID database
1304: Network IF

1. A file storage system comprising:
a server;
a file storage subsystem; and
a network connecting the server and the file storage subsystem;
wherein the server includes an ID management unit for managing an ID of a user capable of accessing a file or a directory or an ID of a group which is an assembly of such users; and
the file storage subsystem includes a table for recording and retaining the ID of the user or the ID of the group capable of accessing the file or the directory that are shared and a hierarchical relationship of the IDs for each file sharing directory, and a control unit for carrying out a processing related to the file and the directory based on the information acquired via the ID management unit;
wherein when a request to delete the ID of the user or the ID of the group stored in the table is acquired via the ID management unit, the control unit refers to the table to specify the file sharing directory to which the ID of the user or the ID of the group related to the deletion request is recorded, carries out a processing required by the deletion request to the files or directories belonging to the specified file sharing directory, and after carrying out the processing, deletes the ID of the user or the ID of the group related to the deletion request from the table.

2. (canceled)

3. The file storage system according to claim 1, wherein
the file storage subsystem comprises a file processing policy for defining a content of processing corresponding to a change of the ID of the user or the ID of the group, regarding files and directories belonging to the file sharing directory to which the ID of the user or the ID of the group is recorded; and
the processing required by the deletion request carried out by the control unit is the content of the processing defined by the file processing policy.

4. The file storage system according to claim 1, wherein
the control unit, via the ID management unit, refers to a log information stored in the server, and obtains the deletion request with respect to the ID of the user or the ID of the group recorded in the table for each file sharing directory from the log information.

5. (canceled)

6. A file storage system comprising:
a server;
a file storage subsystem; and
a network connecting the server and the file storage subsystem;
wherein the server includes an ID management unit for managing an ID of a user capable of accessing a file or a directory or an ID of a group which is an assembly of such users; and
the file storage subsystem includes a table for recording and retaining the ID of the user or the ID of the group capable of accessing the file or the directory that are shared and a hierarchical relationship of the IDs for each file sharing directory, and a control unit for carrying out a processing related to the file and the directory based on the information acquired via the ID management unit;
wherein when a request to participate in a new group or to withdraw from a belonging group is acquired via the ID management unit as a change with respect to the ID of the user or the ID of the group recorded in the table,
in a case where the request is a participation into a new group, the control unit carries out an update processing to the table with respect to the ID within the group, corresponding to the participation, and
in a case where the request is a withdrawal from the belonging group, the control unit refers to the table to specify the file sharing directory to which the ID of the user or the ID of the group related to the withdrawal is recorded, carries out a processing required by the withdrawal to the files or directories belonging to the specified file sharing directory, and after carrying out the processing, deletes the ID of the belonging group related to the withdrawal from the table.

7. The file storage system according to claim 6, wherein
the file storage subsystem comprises a file processing policy for defining a content of processing corresponding to a change of the ID of the user or the ID of the group, regarding files and directories belonging to the file sharing directory to which the ID of the user or the ID of the group is recorded; and
the processing required by the request for withdrawal carried out by the control unit is the content of the processing defined by the file processing policy.

8. The file storage system according to claim 6, wherein
the control unit, via the ID management unit, refers to a log information stored in the server, and obtains the request for participation or withdrawal with respect to the ID of the user or the ID of the group recorded in the table for each file sharing directory from the log information.

9.-10. (canceled)
